(19) United States
(12) Patent Application Publication
(10) Pub. No.: US 2014/0118310 A1
(43) Pub. Date: May 1, 2014

(54) Digital Cursor Display Linked to a Smart Pen

(71) Applicant: Livescribe Inc., Oakland, CA (US)

(72) Inventors: David Robert Black, Sunnyvale, CA (US); Brett Reed Halle, Pleasanton, CA (US); Andrew J. Van Schaack, Nashville, TN (US)

(73) Assignee: Livescribe Inc., Oakland, CA (US)

(21) Appl. No.: 14/062,642

(22) Filed: Oct. 24, 2013

Related U.S. Application Data
(60) Provisional application No. 61/719,291, filed on Oct. 26, 2012.

(51) Int. Cl. G06F 3/041; G06F 3/0354

(52) U.S. Cl. CPC G06F 3/0418; G06F 3/03545
USPC 345/178

(57) ABSTRACT

A system and a method are disclosed for calibrating writing on a writing surface to a digital document. One or more calibration parameters associated with a writing surface and a digital document of a display device are determined. The calibration parameters indicate a spatial offset between a reference position on the writing surface and a reference position in the digital document. A gesture captured by a smart pen is received. The gesture includes a sequence of spatial positions representing movement of the smart pen with respect to the writing surface. The sequence of spatial positions is mapped to a sequence of spatial positions in the digital document based on the calibration parameters.

### CROSS-REFERENCE TO RELATED APPLICATIONS

This application claims the benefit of U.S. Provisional Application No. 61/719,291, entitled “Digital Cursor Display Linked to Smart Pen,” to David Robert Black, Brett Reed Halle, and Andrew J. Van Schaack, filed on Oct. 26, 2012, the contents of which are incorporated by reference herein.

### BACKGROUND

This invention relates generally to pen-based computing systems, and more particularly to synchronizing recorded writing, audio, and digital content in a smart pen environment.

A smart pen is an electronic device that digitally captures writing gestures of a user and converts the captured gestures to digital information that can be utilized in a variety of applications. For example, in an optics-based smart pen, the smart pen includes an optical sensor that detects and records coordinates of the pen while writing with respect to a digitally encoded surface (e.g., a dot pattern). Additionally, some traditional smart pens include an embedded microphone that enable the smart pen to capture audio synchronously with capturing the writing gestures. The synchronized audio and gesture data can then be replayed. Smart pens can therefore provide an enriched note taking experience for users by providing both the convenience of operating in the paper domain and the functionality and flexibility associated with digital environments.

### SUMMARY

Disclosed embodiments include a technique for calibrating writing on a writing surface, using a smart pen based computing system, to a digital document rendered on a display device. In some embodiments, the markups are rendered in the digital document in substantially real-time with respect to the capturing of gestures of the smart pen device.

In one embodiment, a set of calibration parameters is determined. The calibration parameters include information indicating a spatial offset between a reference position on the writing surface and a reference position in the digital document. The reference position may, for example, be an origin point of a coordinate system defined on the writing surface and the digital document. The set of calibration parameters may also include a scaling factor between a writing area on the writing surface and a display of the digital document. Gestures captured by the smart pen are received and mapped to the digital document based on the set of calibration parameters. For instance the gestures are offset or scaled based on the calibration parameters. The received gestures are then rendered in the digital document based on the mapping.

### BRIEF DESCRIPTION OF THE DRAWINGS

FIG. 1 is a schematic diagram of an embodiment of a smart-pen based computing environment.

FIG. 2 is a diagram of an embodiment of a smart pen device for use in a pen-based computing system.

FIG. 3 is a timeline diagram demonstrating an example of synchronized written, audio, and digital content data feeds captured by an embodiment of a smart pen device.

FIG. 4 is a flow diagram illustrating an embodiment of a process for calibrating gesture positioning and sizing/scale relative to a digital document.

FIG. 5 is an interaction diagram illustrating an embodiment of process for controlling the correlation of the relative positioning between a writing surface and digital content.

FIG. 6 is an example interface illustrating a function for scaling gestures relative to a digital document.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview of a Pen-Based Computing Environment

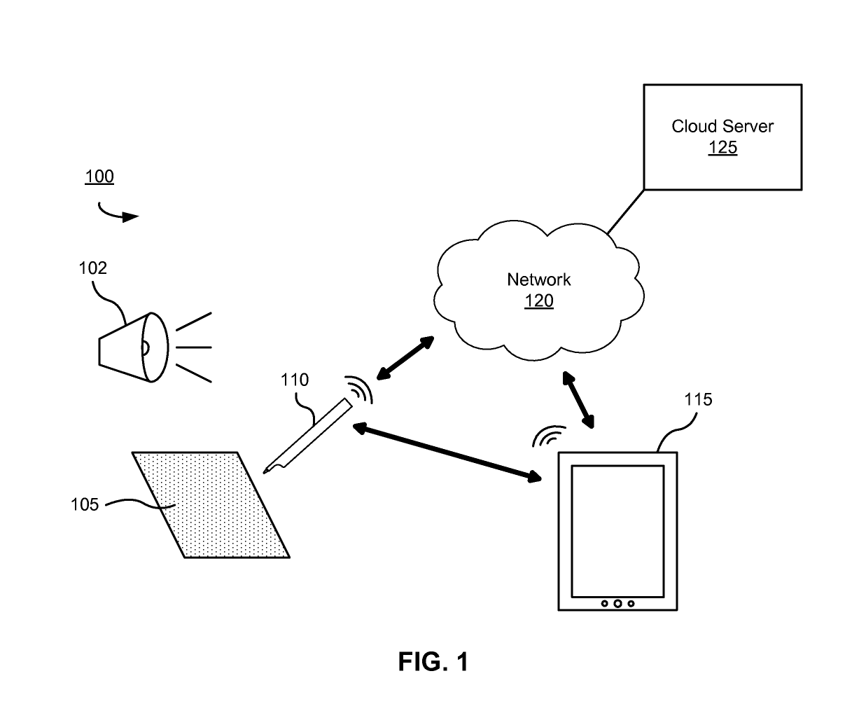

FIG. 1 illustrates an embodiment of a pen-based computing environment 100. The pen-based computing environment comprises an audio source 102, a writing surface 105, a smart pen 110, a computing device 115, a network 120, and a cloud server 125. In alternative embodiments, different or additional devices may be present such as, for example, additional smart pens 110, writing surfaces 105, and computing devices 115 (or one or more device may be absent).

The smart pen 110 is an electronic device that digitally captures interactions with the writing surface 105 (e.g., writing gestures and/or control inputs) and concurrently captures audio from an audio source 102. The smart pen 110 is communicatively coupled to the computing device 115 either directly or via the network 120. The captured writing gestures, control inputs, and/or audio may be transferred from the smart pen 110 to the computing device 115 (e.g., either in real-time or at a later time) for use with one or more applications executing on the computing device 115. Furthermore, digital data and/or control inputs may be communicated from the computing device 115 to the smart pen 110 (either in real-time or an offline process) for use with an application executing on the smart pen 110. The cloud server 125 provides remote storage and/or application services that can be utilized by the smart pen 110 and/or the computing device 115. The computing environment 100 thus enables a wide variety of applications that combine user interactions in both paper and digital domains.

In one embodiment, the smart pen 110 comprises a pen (e.g., an ink-based ball point pen, a stylus device without ink, a stylus device that leaves “digital ink” on a display, a felt marker, a pencil, or other writing apparatus) with embedded computing components and various input/output functionalities. A user may write with the smart pen 110 on the writing surface 105 as the user would with a conventional pen. During the operation, the smart pen 110 digitally captures the writing gestures made on the writing surface 105 and stores electronic representations of the writing gestures. The captured writing gestures have both spatial components and a time component. For example, in one embodiment, the smart pen 110 captures position samples (e.g., coordinate information) of the smart pen 110 with respect to the writing surface 105 at various sample times and stores the captured position information together with the timing information of each sample. The captured writing gestures may furthermore include identifying information associated with the particular writing surface 105 such as, for example, identifying information of a particular page in a particular notebook so as to distinguish between data captured with different writing surfaces 105. In one embodiment, the smart pen 110 also captures other attributes of the writing gestures chosen by the user. For example, ink color may be selected by pressing a physical key on the smart pen 110, tapping a printed icon on the writing surface, selecting an icon on a computer display, etc. This ink information (color, line width, line style, etc.) may also be encoded in the captured data.

The smart pen 110 may additionally capture audio from the audio source 102 (e.g., ambient audio) concurrently with capturing the writing gestures. The smart pen 110 stores the captured audio data in synchronization with the captured writing gestures (i.e., the relative timing between the captured gestures and captured audio is preserved). Furthermore, the smart pen 110 may additionally capture digital content from the computing device 115 concurrently with capturing writing gestures and/or audio. The digital content may include, for example, user interactions with the computing device 115 or synchronization information (e.g., cue points) associated with time-based content (e.g., a video) being viewed on the computing device 115. The smart pen 110 stores the digital content synchronized in time with the captured writing gestures and/or the captured audio data (i.e., the relative timing information between the captured gestures, audio, and the digital content is preserved).

Synchronization may be assured in a variety of different ways. For example, in one embodiment a universal clock is used for synchronization between different devices. In another embodiment, local device-to-device synchronization may be performed between two or more devices. In another embodiment, external content can be combined with the initially captured data and synchronized to the content captured during a particular session.

In an alternative embodiment, the audio and/or digital content 115 may instead be captured by the computing device 115 instead of, or in addition to, being captured by the smart pen 110. Synchronization of the captured writing gestures, audio data, and/or digital data may be performed by the smart pen 110, the computing device 115, a remote server (e.g., the cloud server 125) or by a combination of devices. Furthermore, in an alternative embodiment, capturing of the writing gestures may be performed by the writing surface 105 instead of by the smart pen 110.

In one embodiment, the smart pen 110 is capable of outputting visual and/or audio information. The smart pen 110 may furthermore execute one or more software applications that control various outputs and operations of the smart pen 110 in response to different inputs.

In one embodiment, the smart pen 110 can furthermore detect text or other pre-printed content on the writing surface 105. For example, the smart pen 110 can tap on a particular word or image on the writing surface 105, and the smart pen 110 could then take some action in response to recognizing the content such as playing a sound or performing some other function. For example, the smart pen 110 could translate a word on the page by either displaying the translation on a screen or playing an audio recording of it (e.g., translating a Chinese character to an English word).

In one embodiment, the writing surface 105 comprises a sheet of paper (or any other suitable material that can be written upon) and is encoded with a pattern (e.g., a dot pattern) that can be read by the smart pen 110. The pattern is sufficiently unique to enable to smart pen 110 to determine its relative positioning (e.g., relative or absolute) with respect to the writing surface 105. In another embodiment, the writing surface 105 comprises electronic paper, or e-paper, or may comprise a display screen of an electronic device (e.g., a tablet). In these embodiments, the sensing may be performed entirely by the writing surface 105 or in conjunction with the smart pen 110. Movement of the smart pen 110 may be sensed, for example, via optical sensing of the smart pen device, via motion sensing of the smart pen device, via touch sensing of the writing surface 105, via acoustic sensing, via a fiducial marking, or other suitable means.

The network 120 enables communication between the smart pen 110, the computing device 115, and the cloud server 125. The network 120 enables the smart pen 110 to, for example, transfer captured digital content between the smart pen 110, the computing device 115, and/or the cloud server 125, communicate control signals between the smart pen 110, the computing device 115, and/or cloud server 125, and/or communicate various other data signals between the smart pen 110, the computing device 115, and/or cloud server 125 to enable various applications. The network 120 may include wireless communication protocols such as, for example, Bluetooth, Wifi, cellular networks, infrared communication, acoustic communication, or custom protocols, and/or may include wired communication protocols such as USB or Ethernet. Alternatively, or in addition, the smart pen 110 and computing device 115 may communicate directly via a wired or wireless connection without requiring the network 120.

The computing device 115 may comprise, for example, a tablet computing device, a mobile phone, a laptop or desktop computer, or other electronic device (e.g., another smart pen 110). The computing device 115 may execute one or more applications that can be used in conjunction with the smart pen 110. For example, content captured by the smart pen 110 may be transferred to the computing system 115 for storage, playback, editing, and/or further processing. Additionally, data and or control signals available on the computing device 115 may be transferred to the smart pen 110. Furthermore, applications executing concurrently on the smart pen 110 and the computing device 115 may enable a variety of different real-time interactions between the smart pen 110 and the computing device 115. For example, interactions between the smart pen 110 and the writing surface 105 may be used to provide input to an application executing on the computing device 115 (or vice versa).

In order to enable communication between the smart pen 110 and the computing device 115, the smart pen 110 and the computing device may establish a “pairing” with each other. The pairing allows the devices to recognize each other and to authorize data transfer between the two devices. Once paired, data and/or control signals may be transmitted between the smart pen 110 and the computing device 115 through wired or wireless means.

In one embodiment, both the smart pen 110 and the computing device 115 carry a TCP/IP network stack linked to their respective network adapters. The devices 110, 115 thus support communication using direct (TCP) and broadcast (UDP) sockets with applications executing on each of the smart pen 110 and the computing device 115 able to use these sockets to communicate.

Cloud server 125 comprises a remote computing system coupled to the smart pen 110 and/or the computing device 115 via the network 120. For example, in one embodiment, the cloud server 125 provides remote storage for data captured by the smart pen 110 and/or the computing device 115. Furthermore, data stored on the cloud server 125 can be accessed and used by the smart pen 110 and/or the computing device 115 in the context of various applications.

### Smart Pen System Overview

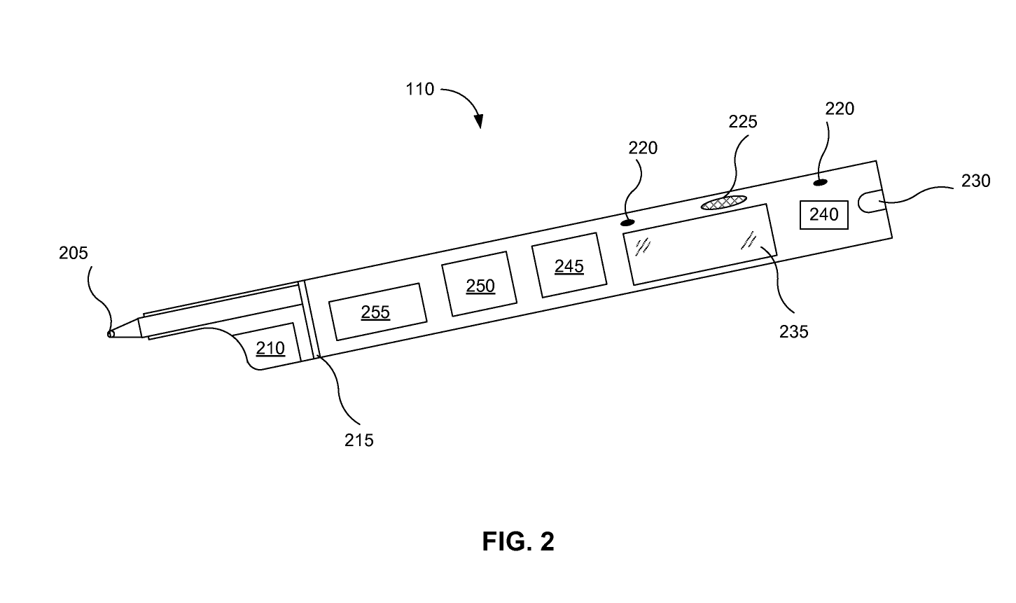

FIG. 2 illustrates an embodiment of the smart pen 110. In the illustrated embodiment, the smart pen 110 comprises a marker 205, an imaging system 210, a pen down sensor 215, one or more microphones 220, a speaker 225, an audio jack 230, a display 235, an I/O port 240, a processor 245, an onboard memory 250, and a battery 255. The smart pen 110 may also include buttons, such as a power button or an audio recording button, and/or status indicator lights. In alternative embodiments, the smart pen 110 may have fewer, additional, or different components than those illustrated in FIG. 2.

The marker 205 comprises any suitable marking mechanism, including any ink-based or graphite-based marking devices or any other devices that can be used for writing. The marker 205 is coupled to a pen down sensor 215, such as a pressure sensitive element. The pen down sensor 215 produces an output when the marker 205 is pressed against a surface, thereby detecting when the smart pen 110 is being used to write on a surface or to interact with controls or buttons (e.g., tapping) on the writing surface 105. In an alternative embodiment, a different type of “marking” sensor may be used to determine when the pen is making marks or interacting with the writing surface 110. For example, a pen up sensor may be used to determine when the smart pen 110 is not interacting with the writing surface 105. Alternative, the smart pen 110 may determine when the pattern on the writing surface 105 is in focus (based on, for example, a fast Fourier transform of a captured image), and accordingly determine when the smart pen is within range of the writing surface 105. In another alternative embodiment, the smart pen 110 can detect vibrations indicating when the pen is writing or interacting with controls on the writing surface 105.

The imaging system 210 comprises sufficient optics and sensors for imaging an area of a surface near the marker 205. The imaging system 210 may be used to capture handwriting and gestures made with the smart pen 110. For example, the imaging system 210 may include an infrared light source that illuminates a writing surface 105 in the general vicinity of the marker 205, where the writing surface 105 includes an encoded pattern. By processing the image of the encoded pattern, the smart pen 110 can determine where the marker 205 is in relation to the writing surface 105. An imaging array of the imaging system 210 then images the surface near the marker 205 and captures a portion of a coded pattern in its field of view.

In other embodiments of the smart pen 110, an appropriate alternative mechanism for capturing writing gestures may be used. For example, in one embodiment, position on the page is determined by using pre-printed marks, such as words or portions of a photo or other image. By correlating the detected marks to a digital version of the document, position of the smart pen 110 can be determined. For example, in one embodiment, the smart pen's position with respect to a printed newspaper can be determined by comparing the images captured by the imaging system 210 of the smart pen 110 with a cloud-based digital version of the newspaper. In this embodiment, the encoded pattern on the writing surface 105 is not necessarily needed because other content on the page can be used as reference points.

In an embodiment, data captured by the imaging system 210 is subsequently processed, allowing one or more content recognition algorithms, such as character recognition, to be applied to the received data. In another embodiment, the imaging system 210 can be used to scan and capture written content that already exists on the writing surface 105. This can be used to, for example, recognize handwriting or printed text, images, or controls on the writing surface 105. The imaging system 210 may further be used in combination with the pen down sensor 215 to determine when the marker 205 is touching the writing surface 105. For example, the smart pen 110 may sense when the user taps the marker 205 on a particular location of the writing surface 105.

The smart pen 110 furthermore comprises one or more microphones 220 for capturing audio. In an embodiment, the one or more microphones 220 are coupled to signal processing software executed by the processor 245, or by a signal processor (not shown), which removes noise created as the marker 205 moves across a writing surface and/or noise created as the smart pen 110 touches down to or lifts away from the writing surface. As explained above, the captured audio data may be stored in a manner that preserves the relative timing between the audio data and captured gestures.

The input/output (I/O) device 240 allows communication between the smart pen 110 and the network 120 and/or the computing device 115. The I/O device 240 may include a wired and/or a wireless communication interface such as, for example, a Bluetooth, Wi-Fi, infrared, or ultrasonic interface.

The speaker 225, audio jack 230, and display 235 are output devices that provide outputs to the user of the smart pen 110 for presentation of data. The audio jack 230 may be coupled to earphones so that a user may listen to the audio output without disturbing those around the user, unlike with a speaker 225. In one embodiment, the audio jack 230 can also serve as a microphone jack in the case of a binaural headset in which each earpiece includes both a speaker and microphone. The use of a binaural headset enables capture of more realistic audio because the microphones are positioned near the user's ears, thus capturing audio as the user would hear it in a room.

The display 235 may comprise any suitable display system for providing visual feedback, such as an organic light emitting diode (OLED) display, allowing the smart pen 110 to provide a visual output. In use, the smart pen 110 may use any of these output components to communicate audio or visual feedback, allowing data to be provided using multiple output modalities. For example, the speaker 225 and audio jack 230 may communicate audio feedback (e.g., prompts, commands, and system status) according to an application running on the smart pen 110, and the display 235 may display word phrases, static or dynamic images, or prompts as directed by such an application. In addition, the speaker 225 and audio jack 230 may also be used to play back audio data that has been recorded using the microphones 220. The smart pen 110 may also provide haptic feedback to the user. Haptic feedback could include, for example, a simple vibration notification, or more sophisticated motions of the smart pen 110 that provide the feeling of interacting with a virtual button or other printed/displayed controls. For example, tapping on a printed button could produce a “click” sound and the feeling that a button was pressed.

A processor 245, onboard memory 250 (e.g., a non-transitory computer-readable storage medium), and battery 255 (or any other suitable power source) enable computing functionalities to be performed at least in part on the smart pen 110. The processor 245 is coupled to the input and output devices and other components described above, thereby enabling applications running on the smart pen 110 to use those components. As a result, executable applications can be stored to a non-transitory computer-readable storage medium of the onboard memory 250 and executed by the processor 245 to carry out the various functions attributed to the smart pen 110 that are described herein. The memory 250 may furthermore store the recorded audio, handwriting, and digital content, either indefinitely or until offloaded from the smart pen 110 to a computing system 115 or cloud server 125.

In an embodiment, the processor 245 and onboard memory 250 include one or more executable applications supporting and enabling a menu structure and navigation through a file system or application menu, allowing launch of an application or of a functionality of an application. For example, navigation between menu items comprises an interaction between the user and the smart pen 110 involving spoken and/or written commands and/or gestures by the user and audio and/or visual feedback from the smart pen computing system. In an embodiment, pen commands can be activated using a “launch line.” For example, on dot paper, the user draws a horizontal line from right to left and then back over the first segment, at which time the pen prompts the user for a command. The user then prints (e.g., using block characters) above the line the desired command or menu to be accessed (e.g., Wi-Fi Settings, Playback Recording, etc.). Using integrated character recognition (ICR), the pen can convert the written gestures into text for command or data input. In alternative embodiments, a different type of gesture can be recognized to enable the launch line. Hence, the smart pen 110 may receive input to navigate the menu structure from a variety of modalities.

### Synchronization of Written, Audio and Digital Data Streams

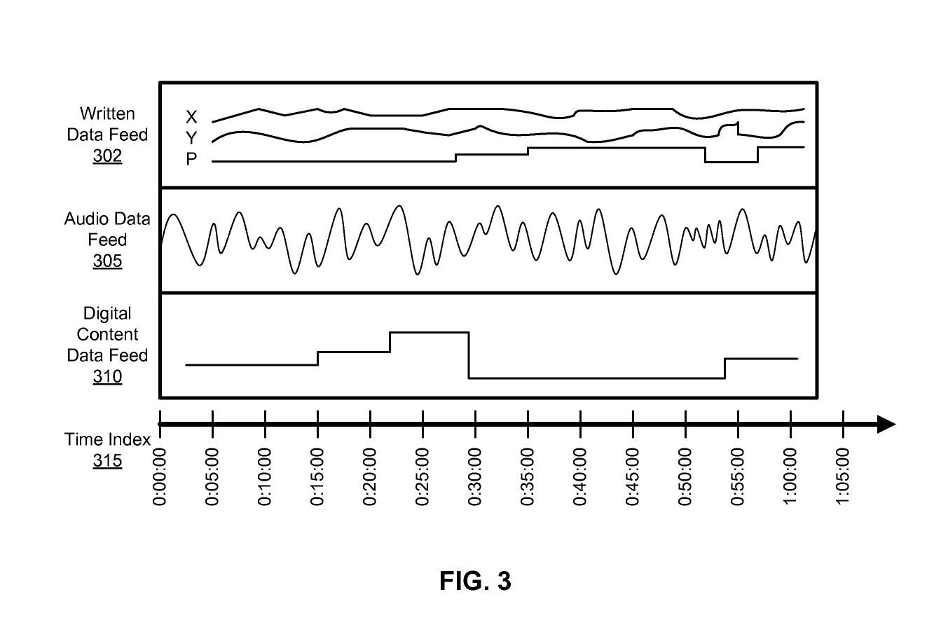

FIG. 3 illustrates an example of various data feeds that are present (and optionally captured) during operation of the smart pen 110 in the smart pen environment 100. For example, in one embodiment, a written data feed 300, an audio data feed 305, and a digital content data feed 315 are all synchronized to a common time index 315. The written data feed 302 represents, for example, a sequence of digital samples encoding coordinate information (e.g., “X” and “Y” coordinates) of the smart pen's position with respect to a particular writing surface 105. Additionally, in one embodiment, the coordinate information can include pen angle, pen rotation, pen velocity, pen acceleration, or other positional, angular, or motion characteristics of the smart pen 110. The writing surface 105 may change over time (e.g., when the user changes pages of a notebook or switches notebooks) and therefore identifying information for the writing surface is also captured (e.g., as page component “P”). The written data feed 302 may also include other information captured by the smart pen 110 that identifies whether or not the user is writing (e.g., pen up/pen down sensor information) or identifies other types of interactions with the smart pen 110.

The audio data feed 305 represents, for example, a sequence of digital audio samples captured at particular sample times. In some embodiments, the audio data feed 305 may include multiple audio signals (e.g., stereo audio data). The digital content data feed 310 represents, for example, a sequence of states associated with one or more applications executing on the computing device 115. For example, the digital content data feed 310 may comprise a sequence of digital samples that each represents the state of the computing device 115 at particular sample times. The state information could represent, for example, a particular portion of a digital document being displayed by the computing device 115 at a given time, a current playback frame of a video being played by the computing device 115, a set of inputs being stored by the computing device 115 at a given time, etc. The state of the computing device 115 may change over time based on user interactions with the computing device 115 and/or in response to commands or inputs from the written data feed 302 (e.g., gesture commands) or audio data feed 305 (e.g., voice commands). For example, the written data feed 302 may cause real-time updates to the state of the computing device 115 such as, for example, displaying the written data feed 302 in real-time as it is captured or changing a display of the computing device 115 based on an input represented by the captured gestures of the written data feed 302. While FIG. 3 provides one representative example, other embodiments may include fewer or additional data feeds (including data feeds of different types) than those illustrated.

As previously described, one or more of the data feeds 302, 305, 310 may be captured by the smart pen 110, the computing device 115, the cloud server 120 or a combination of devices in correlation with the time index 315. One or more of the data feeds 302, 305, 310 can then be replayed in synchronization. For example, the written data feed 302 may be replayed, for example, as a “movie” of the captured writing gestures on a display of the computing device 115 together with the audio data feed 305. Furthermore, the digital content data feed 310 may be replayed as a “movie” that transitions the computing device 115 between the sequence of previously recorded states according to the captured timing.

In another embodiment, the user can then interact with the recorded data in a variety of different ways. For example, in one embodiment, the user can interact with (e.g., tap) a particular location on the writing surface 105 corresponding to previously captured writing. The time location corresponding to when the writing at that particular location occurred can then be determined. Alternatively, a time location can be identified by using a slider navigation tool on the computing device 115 or by placing the computing device 115 is a state that is unique to a particular time location in the digital content data feed 210. The audio data feed 305, the digital content data feed 310, and or the written data feed may be re-played beginning at the identified time location. Additionally, the user may add to modify one or more of the data feeds 302, 305, 310 at an identified time location.

### Gesture Calibrations on Digital Documents

Conventionally, markups to a digital document are performed using a mouse, touchscreen, or keyboard. This method is uncomfortable for users because it does not reflect the natural writing experience. Using a smart pen 110, users are able to write and make markups in a digital document in a more familiar way. Such markups can include, for example, making marks or annotations on a digital document that may be useful to communicate desired changes or feedback. Additionally, markups may be used to convey information desirable for completing a digital document such as filling out a form or entering a signature. By correlating the input of a smart pen 110 interacting with a writing surface 105 to digital content being viewed on a computing device 115, the user can write, draw, or sign using a highly accurate and familiar input device, while recording their input in a form that can be overlaid on top of the digital content for sharing, printing, or archiving.

In one embodiment, the smart pen 110 is calibrated relative to the digital document prior to capturing the markups. This enables the user to specify the relative positioning and scale of the captured writing gestures independently of the layout of the digital document or the size of the writing surface 105. One example of this might be a digital signature pad, where a user signs on a writing surface 105 with the intention of rendering the signature to a particular location on a digital document and having a particular size that may be of arbitrary positioning and scale relative to user's signature on the writing surface 105.

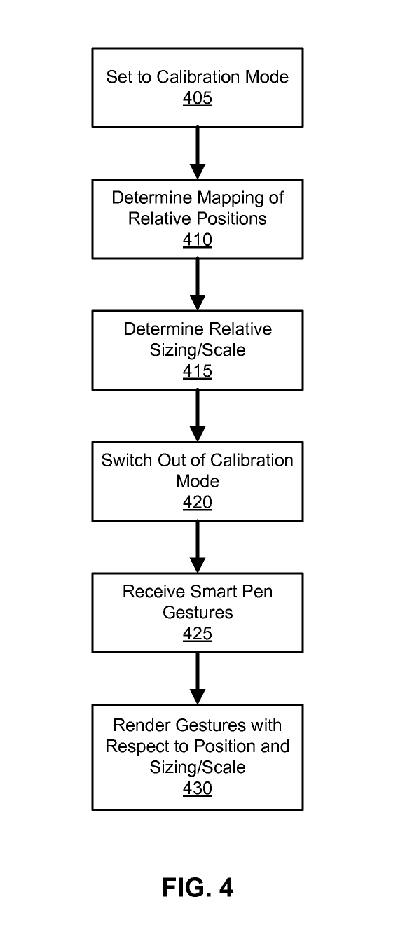

FIG. 4 is a flow diagram illustrating an embodiment of a process for using the smart pen 110 to provide markups on a digital document. To begin, a smart pen 110 and/or a computing device 115 is first set 405 to a “calibration mode.” In this mode, the smart pen 110 and computing device 115 are configured to detect and correlate coordinates and scaling between the writing surface 105 and the computing device 115. The smart pen 110 and computing device 115 determine 410 a mapping between relative reference positions on the writing surface 105 and the digital document. For example, the smart pen 110 detects an initial coordinate on the writing surface 105 that will correspond to an initial coordinate on the digital document following the calibration. The user can move the initial coordinate on the digital document to set a new reference coordinate that will be mapped to the pen's current position. After locking this coordinate in place, writing on the writing surface 105 will appear on the digital document at the mapped coordinate of the digital document. In one embodiment, a default coordinate mapping (e.g., a direct 1:1 coordinate mapping) is used absent any change during the calibration process.

In addition to determining 410 the relative position of new gestures, the computing device 115 also determines 415 the relative scale between the gestures on the writing surface 105 and the rendered gestures on the computing device 115. In one embodiment, a shaded box is displayed on the computing device 115 that represents the relative size of the writing surface 105 with respect to the digital document. By changing the size of the shaded box, the user can change the relative scale of gestures captured on the writing surface that will appear on the digital document following the calibration. A user can thus change the size of the markups on the digital document without changing the size of the actual marks on the writing surface 105. Being able to control the size of gestures can be useful for accurately overlaying markups on the digital content. In one embodiment, a default scaling (e.g., 1:1) may be used absent any changes during the calibration process.

The computing device 115 and/or smart pen 110 are then switched 420 out of calibration mode and the user is ready to begin marking up the digital document. The computing device 115 receives 425 gestures from the smart pen 110 as the user writes on the writing surface 105 with the smart pen 110. As described above, the smart pen gestures are processed and rendered 430 on the computing device 115 (e.g., in real-time), with the positioning and scaling of the gestures correlated to the digital document based on the positioning and scaling set during the calibration mode.

### Smart Pen Hover Mode

In one embodiment, a “hover mode” of the smart pen 110 is used to assist the user in changing the mapping of coordinates on the writing surface to coordinates on the digital document.

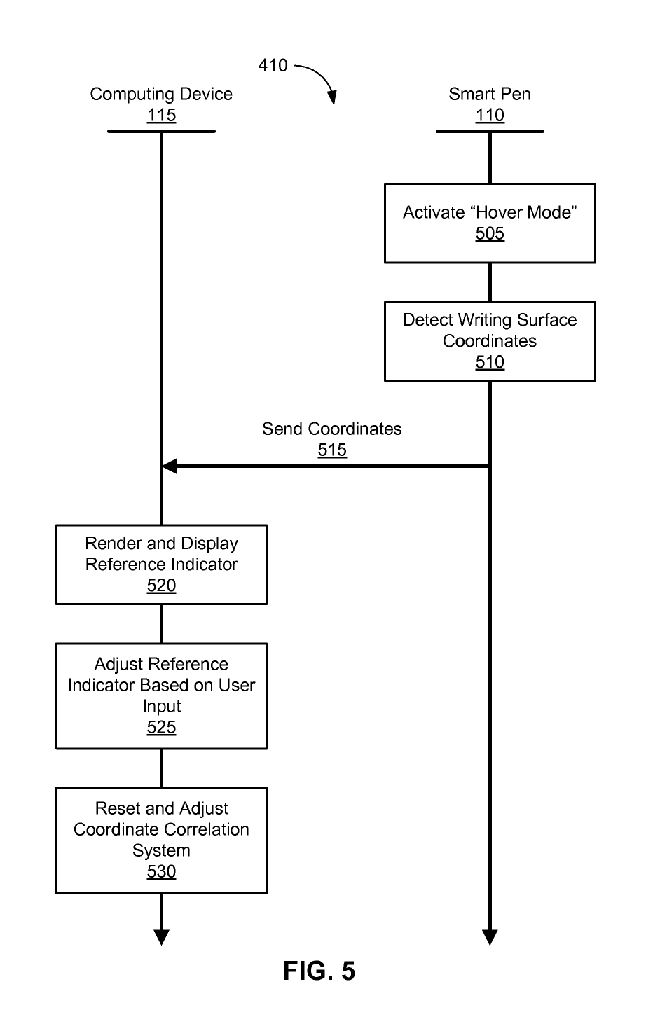

FIG. 5 illustrates an embodiment of a process for calibrating the reference locations using the hover mode. The smart pen 110 activates 505 the hover mode to begin the calibration. In hover mode, the smart pen 110 scans the writing surface 105 and detects 510 coordinates indicating the current location of the pen tip in relation to the writing surface 105, regardless of whether the pen tip is in contact with the writing surface 105. For example, if the writing surface 105 is dot paper, the smart pen 110 detects the specific dot pattern on the paper and generates a continual stream of dot paper coordinates that adjusts as the pen moves over the writing surface 105, as long as the smart pen 110 is focused and in range of the dot pattern. These coordinates are used by the smart pen 110 and the computing device 115 as the base coordinates for positioning calibrations. The specific coordinate that the pen is hovering over at any given moment correlates to an origin coordinate on the digital document. The coordinates detected by the smart pen 110 are sent 515 to the connected computing device 115 and the computing device 115 renders and displays 520 a reference indicator at the origin coordinate on a digital document. This reference indicator gives the user context as to where in the digital document input gestures will appear on the computing device 115 when the user begins writing.

The user can adjust 525 the reference indicator on the computing device 115 to change the location of the origin coordinate on the computing device 115 in relation to the where the smart pen 110 is hovering over the writing surface 105. This resets and adjusts 530 the mapping of coordinates between the writing surface 105 and digital document. Gestures written on the writing surface 105 will therefore appear in a different location on the digital document. For example, the smart pen 110 can be calibrated such that positioning the smart pen 110 at the upper left corner of the writing surface 105 will cause the reference indicator to appear at the center of the digital document.

In one embodiment, the reference indicator appears as a “cursor” that is displayed on the computing device 115. The user can adjust 525 the positioning of that cursor by moving it around on the computing device's display. On a touchscreen device, this could be done by touching the cursor and dragging it around the screen. On a non-touchscreen device, the user can click and drag the cursor using a mouse or other input device. Releasing the selection of the cursor locks the coordinates in place and maps those coordinates on the digital document to the coordinates of the smart pen's current position over the writing surface. This mapping is used to position the rendered gestures on digital document during subsequent writing activities.

In another embodiment, “hover mode” can be used to alter the positioning of gestures that have already been entered. Using similar methods as in the other embodiments, the user can shift the positioning of groups of previously written gestures. In this situation, the existing gestures would be re-rendered on the digital content with a new relative positioning applied during drag and zoom operations. For example, a user's signature at a particular position on the writing surface 105 may already be linked to a digital document and rendered at a particular position on the digital document. However, the user may want to move the same signature to another location on the digital document, or to a different page of the digital document. Hover mode can be used to select the signature, realign it on the page, and lock it in place so that the signature fits the new intended signature location. Similarly, large blocks of gesture or audio content correlated to a digital document may also be copied and moved to other sections of the same (or different) documents. For example, a user making repetitive comments on several documents may have a template gesture set already prepared. The user can copy and paste the same set of gestures to each document. Linked audio and other data may also be copied to the new location. For example, in a classroom scenario, an instructor could make comments on one document and then easily transfer them to multiple students' documents.

### Gesture Resizing

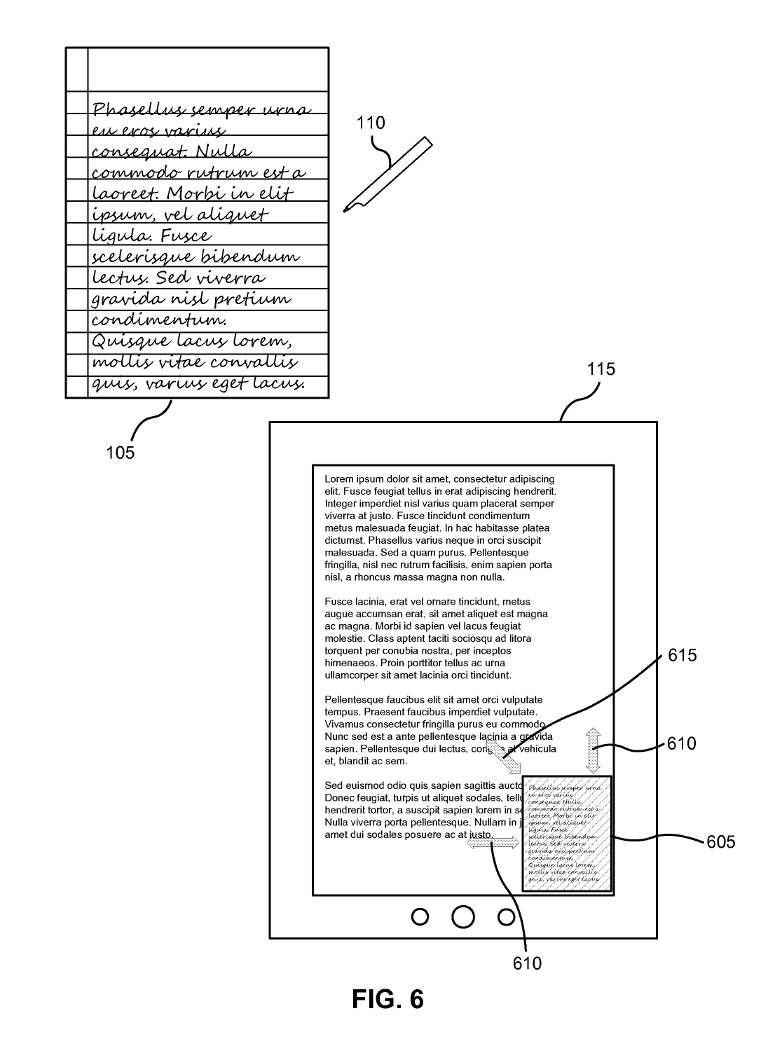

In addition to relocating the initial coordinates of gestures on a digital document, users can also change the size of the gestures that appear on the digital document in relation to the size of the gestures on writing surface 105. FIG. 6 is an embodiment of an interface illustrating a function for scaling gestures relative to a digital document. In this embodiment, a shaded box 605 is displayed superimposed on a digital document in a computing device 115. The shaded box 605 represents the writing surface 105 so that gestures written on writing surface 105 will appear proportionally scaled inside the shaded box 605. This shaded box 605 can be adjusted on the computing device 115 to change the relative size of the gestures on the digital document. For example, the shaded box 605 can be enlarged or shrunk 610, or it can be moved 615 around in the display area of computing device 115. A smaller shaded box 605 may indicate that rendered gestures will be smaller whereas a larger shaded box 605 may indicate that rendered gestures are larger. The size of the shaded box 605 can be changed accordingly in order to change the size of the rendered gestures. For example, the shaded boxes 605 can be scaled on a touchscreen device by using a “pinch zoom” (touching two fingers on the display and dragging them closer or farther from each other) or on a non-touchscreen device by using a scroll wheel or other secondary range input device.

The properties of the shaded box 605 may also change to notify the user of certain circumstances. In an embodiment, the shaded box 605 may change to a different shading pattern when the box 605 has been enlarged to be bigger than the display. The pattern indicates to the user that the gestures have been scaled to be bigger than a 1:1 mapping between the writing surface 105 and the digital document page size. If this were to occur, the gestures would still be rendered proportionally scaled a rectangular area larger than the display of the computing device 115. However, part of the gestures may be rendered off-screen if the scaled gestures fall outside the boundaries of the screen of the computing device 115.

As discussed above, it is also possible to modify scaling of gestures that have already been previously captured and displayed. Here, gestures may be selected on the computing device and scaled by the user (e.g., using a pinch zoom). The gestures are then re-rendered and stored using the new scaling.

In an embodiment, using various combinations of the aforementioned methods, different variations of gesture modifications may also be performed. For example, some of these modifications may include, but is not limited to, rotation of the gestures, skewing of the gestures, flipping of the gestures, inverting the gestures and so forth. Furthermore, the properties of the digital ink may also be changed (e.g., ink color, line thickness, font selection and so forth).

### Additional Embodiments

The foregoing description of the embodiments has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program instructions, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for calibrating writing on a writing surface to a digital document, the method comprising:
determining one or more calibration parameters associated with a writing surface and a digital document of a display device, the one or more calibration parameters indicating:
a spatial offset between a reference position on the writing surface and a reference position in the digital document, and
a scaling factor between the writing surface and the digital document;
receiving a gesture captured by a smart pen, the gesture comprising a sequence of spatial positions of the smart pen representing movement of the smart pen with respect to the writing surface;
mapping, by a computing device, the sequence of spatial positions of the smart pen to a sequence of spatial positions in the digital document based on the one or more calibration parameters;
rendering the received gesture in the digital document on the display device based on the mapped sequence of spatial positions in the digital document.

2. The method of claim 1, wherein determining the one or more calibration parameters comprises:
displaying a box on the computing device, the box representing an area in the digital document corresponding to the writing surface and the box having a size relative to a size of a visible display region of the display device based on the scaling factor;
responsive to receiving a request to resize the box, determining the scaling factor based on a resizing factor of the request.

3. The method of claim 2, wherein the box is a shaded box, the method further comprising:
responsive to determining that the box exceeds visible area of the display device, changing a displayed pattern filling the box.

4. The method of claim 1, wherein determining the one or more calibration parameters comprises:
determining the reference position on the writing surface based on a coordinate on the writing surface captured by the smart pen;
determining, based on a user interaction with the display device, an initial coordinate in the digital document;
displaying a reference indicator at the initial coordinate in the digital document; and
determining the reference position in the digital document based on a position of the reference indicator.

5. The method of claim 4, wherein determining the reference position on the writing surface comprises:
receiving the reference position from the smart pen, wherein a marker of the smart pen is not in contact with the writing surface when the smart pen detects the coordinate.

6. The method of claim 4, wherein determining the reference position in the digital document comprises:
receiving a user request to move the reference indicator to a new position; and
responsive to the request to move the reference indicator to the new position, mapping the reference position in the digital document to the new position.

7. The method of claim 1, wherein the rendering is performed in substantially real-time with respect to the receiving go the gestures captured by the smart pen.

8. A system for mapping gestures into a digital document, the system comprising:
a smart pen configured to:
an input device to receive a request to activate a hover mode of the smart pen, the hover mode for calibrating gestures on a writing surface captured by the smart pen device with respect to a digital document; and
a capture system to detect a sequence of spatial positions indicating a current location of a pen tip of the smart pen device in relation to the writing surface while in the hover mode; and
an output device to transmit the sequence of spatial positions to a computing device; and
a non-transitory computer readable storage medium configured to store instructions, the instructions when executed by a processor of the computing device, cause the processor to:
receive, from the smart pen device, the sequence of spatial positions indicating the current location of the pen tip of the smart pen; and
determining one or more calibration parameters associated with the writing surface and a digital document displayed on the computing device, the one or more calibration parameters indicating a spatial offset between a reference position on the writing surface and a reference position in the digital document and the one or more calibration parameters indicating a scaling factor between the writing surface and the digital document;
display a reference indicator on a display of the computing system, a position of the reference indicator based on the received sequence of spatial positions and the one or more calibration parameters.

9. The system of claim 8, wherein the smart pen detects the sequence of spatial positions without the pen tip being in contact with the writing surface.

10. The system of claim 8, wherein the computer readable medium is further configured to store instructions that further cause the processor to:
receive a request to change scaling factor of the calibration parameters; and
adjusting the reference indicator in the digital document based on the scaling factor.

11. The system of claim 10:
wherein the smart pen device is further configured to:
detect whether a tip of the smart pen is in contact with the writing surface; and
responsive to the detecting that the tip of the smart pen is in contact with the writing surface, send an indication to the computing device that the tip of the pen is in contact with the writing surface; and
wherein the computer readable medium is further configured to store instructions that further cause the processor to:
responsive to receiving the indication that the tip of the pen is in contact with the writing surface, display gestures being captured by the smart pen device, in the digital document based on the spatial offset between the reference position on the writing surface and the reference position in the digital document.

12. The system of claim 8, wherein the computer readable medium is further configured to store instructions that further cause the processor to:
receive a request to change the position of the reference indicator; and
adjusting the reference position in the digital document based on the request.

13. The system of claim 8, wherein the smart pen is further configured to:
send, in substantially real-time, the detected sequence of spatial positions to the computing system.

14. The system of claim 8, wherein the computer readable medium is further configured to store instructions that cause the processor to:
display a box on the computing device, the box representing an area in the digital document corresponding to the writing surface and the box having a size relative to a size of a visible display region of the display device based on the scaling factor;
responsive to receiving a request to resize the box, determine the scaling factor based on a resizing factor of the request.

15. A non-transitory computer readable medium configured to store instructions for calibrating writing on a writing surface to a digital document, the instructions when executed by a processor cause the processor to:
determine one or more calibration parameters associated with a writing surface and a digital document of a display device, the one or more calibration parameters indicating a spatial offset between a reference position on the writing surface and a reference position in the digital document and the one or more calibration parameters indicating a scaling factor between the writing surface and the digital document;
receive a gesture captured by a smart pen, the gesture comprising a sequence of spatial positions of the smart pen representing movement of the smart pen with respect to the writing surface;
map the sequence of spatial positions of the smart pen to a sequence of spatial positions in the digital document based on the one or more calibration parameters;
render the received gesture in the digital document on the display device based on the mapped sequence of spatial positions in the digital document.

16. The computer readable medium of claim 15, wherein the one or more calibration parameters further indicate a scaling factor between the writing surface and the digital document, and wherein the instructions for determining the one or more calibration parameters, when executed by the processor causes the processor to:
display a box on the computing device, the shaded box representing an area in the digital document corresponding to the writing surface and the box having a size relative to a size of a visible display region of the display device based on the scaling factor;
responsive to receiving a request to resize the box, determine the scaling factor based on a resizing factor or the request.

17. The computer readable medium of claim 16, further comprising:
responsive to determining that the box is exceeds a visible area of the display device, changing a displayed pattern filling the box.

18. The computer readable medium of claim 15, wherein the instructions for determining the one or more calibration parameters, when executed by the processor causes the processor to:
determine the reference position on the writing surface based on a coordinate on the writing surface captured by the smart pen;
determine, based on a user interaction with the display device, an initial coordinate in the digital document;
display a reference indicator at the initial coordinate in the digital document; and
determine the reference position in the digital document based on a position of the reference indicator.

19. The computer readable medium of claim 18, wherein the instructions for determining the reference position on the writing surface, when executed by the processor causes the processor to:
receive the reference position from the smart pen, wherein a marker of the smart pen is not in contact with the writing surface when the smart pen detects the coordinate.

20. The computer readable medium of claim 18, wherein the instructions for determining the reference position in the digital document, when executed by the processor causes the processor to:
receive a user request to move the reference indicator to a new position; and
responsive to the request to move the reference indicator to the new position, map the reference position in the digital document to the new position.
